(19) United States
(12) Patent Application Publication
(10) Pub. No.: US 2009/0317985 A1
(43) Pub. Date: Dec. 24, 2009

(54) Magnetic Interconnection Device

(75) Inventors: James M. Irion, II, Allen, TX (US); Brian W. Johansen, McKinney, TX (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/489,015

(22) Filed: Jun. 22, 2009

Related U.S. Application Data
(60) Provisional application No. 61/132,872, filed on Jun. 23, 2008.
(60) Provisional application No. 61/132,849, filed on Jun. 23, 2008.

(51) Int. Cl. H01R 11/30

(52) U.S. Cl. 439/39

(57) ABSTRACT

According to one embodiment, a first magnetic coupling element is coupled to a first conductive element of a first electrical circuit. A second magnetic coupling element is coupled to a second conductive element of a second electrical circuit. The second magnetic coupling element is operable to attract the first magnetic coupling element using a magnetic force such that electrical contact is made between the first conductive element and the second conductive element

### RELATED APPLICATIONS

Pursuant to 35 U.S.C. §119(e), this application claims priority to U.S. Provisional Patent Application Ser. No. 61/132,872, entitled MAGNETIC INTERCONNECTION DEVICE, filed Jun. 23, 2008. U.S. Provisional Patent Application Ser. No. 61/132,872 is hereby incorporated by reference.

Pursuant to 35 U.S.C. §119(e), this application claims priority to U.S. Provisional Patent Application Ser. No. 61/132,849, entitled DUAL-POLARIZED ANTENNA ARRAY, filed Jun. 23, 2008. U.S. Provisional Patent Application Ser. No. 61/132,849 is hereby incorporated by reference.

### TECHNICAL FIELD OF THE DISCLOSURE

This disclosure generally relates to electrical circuit devices, and more particularly, to a magnetic interconnection for forming electrical interconnections between conductive elements.

### BACKGROUND OF THE DISCLOSURE

Electrical circuits may employ a number of electrical components, such as resistors, capacitors, inductors, or integrated circuits to supply a useful function. These electrical components may be implemented on one or more circuit cards or other generally rigid or non-rigid structure. The one or more circuit cards may have conductive traces that interconnect the various nodes of the electrical components. In some cases, electrical circuits may be implemented on multiple circuit cards for various reasons, such as to simplify their manufacturing process or segregate components of the electrical circuit according to its modular building blocks.

### SUMMARY OF THE DISCLOSURE

According to one embodiment, a first magnetic coupling element is coupled to a first conductive element of a first electrical circuit. A second magnetic coupling element is coupled to a second conductive element of a second electrical circuit. The second magnetic coupling element is operable to attract the first magnetic coupling element using a magnetic force such that electrical contact is made between the first conductive element and the second conductive element Some embodiments of the present disclosure may provide numerous technical advantages. A technical advantage of one embodiment may be enhanced electrical interconnections between circuits. Another technical advantage of one embodiment may include the ability to provide compact electrical interconnections while being relatively easy to disassemble. Another technical advantage of one embodiment may include the capability to protect electrical interconnections against vibration damage. Another technical advantage of one embodiment may include the capability to lower construction costs and mass-produce circuit components.

Although specific advantages have been disclosed hereinabove, it will be understood that various embodiments may include all, some, or none of the disclosed advantages. Additionally, other technical advantages not specifically cited may become apparent to one of ordinary skill in the art following review of the ensuing drawings and their associated detailed description.

### BRIEF DESCRIPTION OF THE DRAWINGS

A more complete understanding of embodiments of the disclosure will be apparent from the detailed description taken in conjunction with the accompanying drawings in which:

FIGS. 1A and 1B show one embodiment of an electrical interconnection device according to the teachings of the present disclosure;

FIGS. 2A and 2B show alternative configurations of the electrical interconnection device of FIGS. 1A and 1B;

FIGS. 3A and 3B show isometric and crosssection views, respectively, of an electrical interconnection device according to another embodiment;

FIG. 3C shows an alternative embodiment of the electrical interconnection device of FIGS. 3A and 3B;

FIGS. 4A and 4B show isometric and crosssection views, respectively, of an electrical interconnection device according to another embodiment;

FIG. 4C shows an alternative embodiment of the electrical interconnection device of FIGS. 4A and 4B;

FIGS. 5A and 5B show an electrical interconnection device according to another embodiment;

FIG. 5C shows an alternative embodiment of the electrical interconnection device of FIGS. 5A and 5B;

FIGS. 6A and 6B show alternative embodiments of the electrical interconnection device of FIGS. 5A and 5B; and

FIGS. 7 and 8 show various properties of several types of magnets that may be used with an electrical interconnection device.

### DETAILED DESCRIPTION OF EXAMPLE EMBODIMENTS

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

Known circuit interconnection mechanisms, such as electrical connectors or solder connections, may create problems in certain implementations. Electrical connectors typically incorporate a relatively bulky physical structure that may hinder its use in physically small applications. Furthermore, in applications having numerous interconnection paths, electrical connectors having many contacts may be difficult to manage due to the relatively large amount of insertion force required. Soldered connections, on the other hand, may be relatively difficult to disassemble and may be prone to damage due to vibration. Accordingly, teachings of certain embodiments recognize that magnetic interconnection devices may provide an alternative technique for electrical interconnection of circuit cards or other structures. For example, teachings of certain embodiments recognize that electrical interconnection devices may be incorporated into a variety of circuits, such as stripline, microstrip, coplaner waveguide, digital, DC, and any other suitable circuits.

Teachings of certain embodiments further recognize that magnetic interconnection devices may be incorporated into an antenna or an antenna array. As a non-limiting example, magnetic interconnection devices may be incorporated into an antenna array such as the antenna array of U.S. application entitled “Dual-Polarized Antenna Array”, which is being filed concurrently, for Attorney Docket 004578.1812. Teachings of certain embodiments recognize that the ability to disassemble magnetic interconnects may be especially beneficial in the context of antennas and antenna arrays.

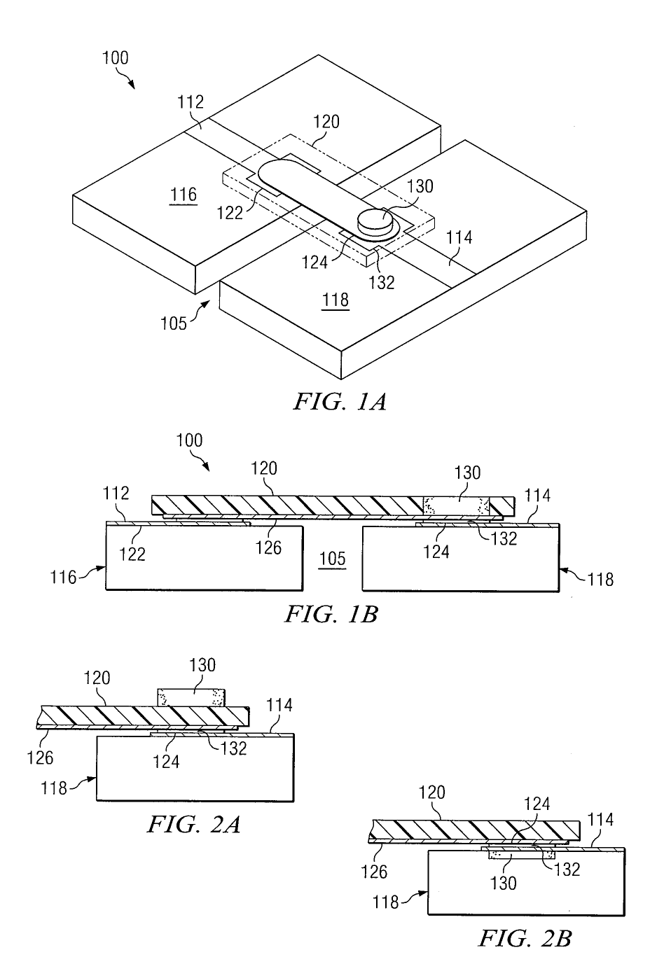

FIGS. 1A and 1B show an electrical interconnection device 100 according to one embodiment. This example features a first conductive element 112 and a second conductive element 114. The first conductive element 114 is coupled with a first substrate 116, and the second conductive element 114 is coupled with a second substrate 118. In the illustrated embodiment, the first and second substrates 116 and 118 are separated by a slot 105. A third substrate 120 spans the slot 105 and couples to the first and second substrates 116 and 118 at points 122 and 124, respectively. A third conductive element 126 is coupled to the third substrate 120.

The first, second, and third substrates 116, 118, and 120 may be comprised of any suitable material. Embodiments of the first, second, and third substrates 116, 118, and 120 may include both rigid and flexible materials. In one embodiment, one or more of the substrates 112, 114, and 120 may be comprised of a flexible circuit substrate. In another embodiment, the substrates 112, 114, and 120 may be comprised of a circuit board material. The first, second, and third conductive elements 112, 114, and 126 may also be comprised of any suitable material. For example, in one embodiment, one or more of the elements 112, 114, and 122 may include a relatively thin strip of copper. In some embodiments, the elements 112, 114, and 122 may be integrally formed with the substrates 112, 114, and 120.

The third conductive element 126 may couple to first and second conductive elements 112 and 114 according to any suitable mechanism. For example, the embodiment of FIGS. 1A and 1B illustrates two available mechanisms. In this example, the third conductive element 126 is soldered to the first conductive element 112 at the point 122. The third conductive element 126 attaches to the second conductive element 114 at the point 124 using a magnet 130 and a magnetic coupler 132. The magnet 130 is coupled to the third substrate 130, and the magnetic coupler 132 is coupled to the second substrate 118. When the magnet 130 is placed in close proximity to the magnetic coupler 132, a magnetic attractive force is developed that causes the third conductive element 120 to contact the second conductive element 114. Thus, in this example, an electrical interconnection between the first and second conductive elements 112 and 114 may be established through the third conductive element 126.

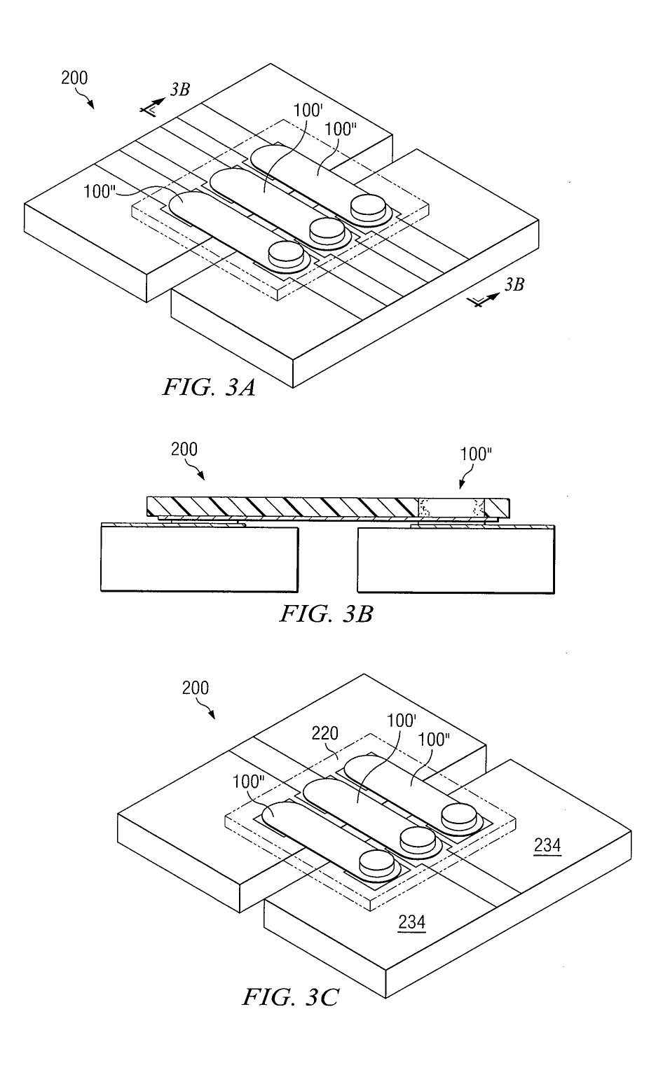

The magnet 130 and the magnetic coupler 132 may be configured in any suitable arrangement. For example, in FIG. 1B, the magnet 130 is embedded into the third substrate 120. FIGS. 2A and 2B show two additional examples of magnetic coupling arrangements. In FIG. 2A, the magnet 130 is mounted on the surface of the third substrate 120. In FIG. 2B, magnet 130 is embedded into the second substrate 114. Embodiments of the magnet 130 and the magnetic coupler 132 may be incorporated into one, some, or all of the first substrate 116, the second substrate 118, and the third substrate 120.

In some embodiments, the magnet 130 and/or the magnetic coupler 132 may be electrically coupled to the third conductive element 126 and the second conductive element 114, respectively. In these embodiments, the magnet 130 and/or the magnetic coupler 132 may be incorporated into the circuit that completes the connection between the third conductive element 126 and the second conductive element 114. In other embodiments, the magnet 130 and/or the magnetic coupler 132 may attract the third conductive element 126 to the second conductive element 114 without being incorporated into the circuit that completes the connection between elements 114 and 126.

The magnet 130 and the magnetic coupler 132 may be coupled to their respective conductive elements and/or substrates using any suitable approach, such as with conductive epoxy. In some embodiments, the magnet 130 has a surface that is oriented towards the magnetic coupler 132 when mated together. In some embodiments, the surface of the magnet 130 may be implemented with a layer of conductive material, such as gold, to improve electrical contact between the first conductive element 112 and the second conductive element 118.

FIGS. 3A and 3B show isometric and crosssection views, respectively, of an electrical interconnection device 200 according to one embodiment. The crosssection view of FIG. 3B shown from the perspective of axis A of FIG. 3A.

In this example, the electrical interconnection device 200 incorporates multiple electrical interconnection devices 100. In this particular embodiment, the electrical interconnection device 200 incorporates three interconnection devices 100. The center interconnection device is shown as 100′, and the outside interconnection devices are shown as 100″. Teachings of certain embodiments recognize that additional circuits may enable the electrical interconnection device 200 to operate as part of a coplaner waveguide. Teachings of certain embodiments also recognize that multiple electrical interconnection devices 100 may be incorporated in scenarios where additional grounding is needed to span a bridge distance.

FIG. 3C shows an alternative embodiment of the electrical interconnection device 200 in which the two outer electrical interconnection devices 100″ couple ground planes 234 on either side of a conductive element 220. In this embodiment, one example of the conductive element 220 may include the third conductive element 120 of FIG. 1A-1B.

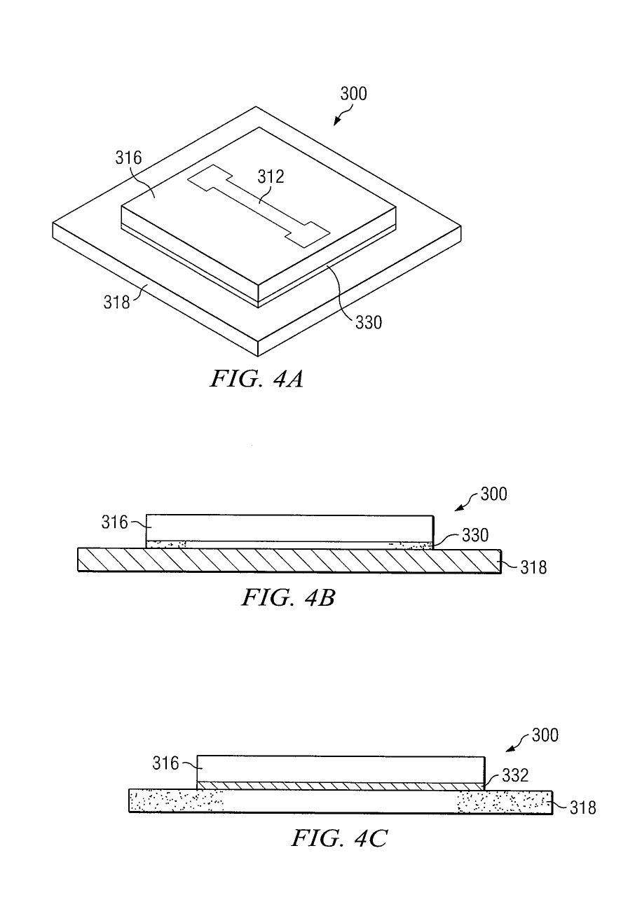

FIGS. 4A and 4B show isometric and side views, respectively, of an electronic interconnect device 300 according to one embodiment. This example features a first substrate 116 and a second substrate 118. In the example embodiment, the first substrate 116 and the second substrate 118 are shown as a circuit card and a carrier plate, respectively. Teachings of certain embodiments recognize that a circuit card may be attached to a carrier plate using a magnetic interface along ground plane surfaces. Teachings of certain embodiments recognize the capability to attach and remove an entire circuit from a carrier, as well as use magnetic interconnects to from connections between adjacent cards. However, embodiments are not limited to the example circuit card and carrier plate configuration.

In this example, the first substrate 316 is coupled to a magnetic layer 330. The magnetic layer 330 provides for releasable attachment to the second substrate 318. In this example embodiment, the carrier plate may be made of a ferromagnetic material. The first substrate 316 may have one or more conductive elements 312, such as copper traces, resistors, capacitors, integrated circuits, or the like, that may be electrically coupled to contact surfaces (not shown) that make electrical contact with complimentary contact surfaces configured on the second substrate 318.

FIG. 4C shows an alternative embodiment of the electrical interconnection device 300 in which the first substrate 316 is attached to a ferromagnetic layer 332. In this example, the second substrate 318 is made of a magnetic material.

Teachings of certain embodiments recognize that magnetic interconnect devices and electrical elements may be incorporated in a variety of antenna circuits, such as stripline, microstrip, coplaner waveguide, digital, DC, and any other suitable circuits. Although only a few example embodiments are shown, antenna configurations are not limited to the illustrative embodiments shown.

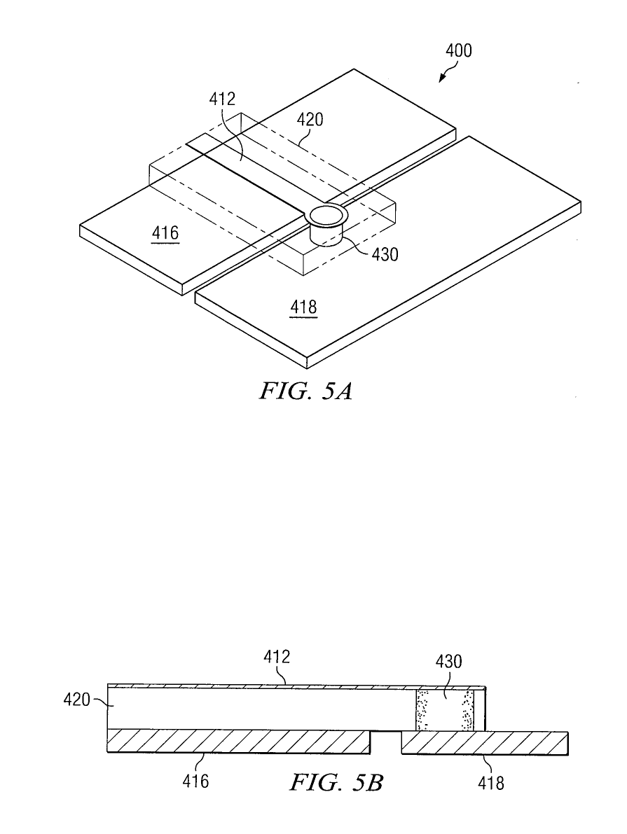

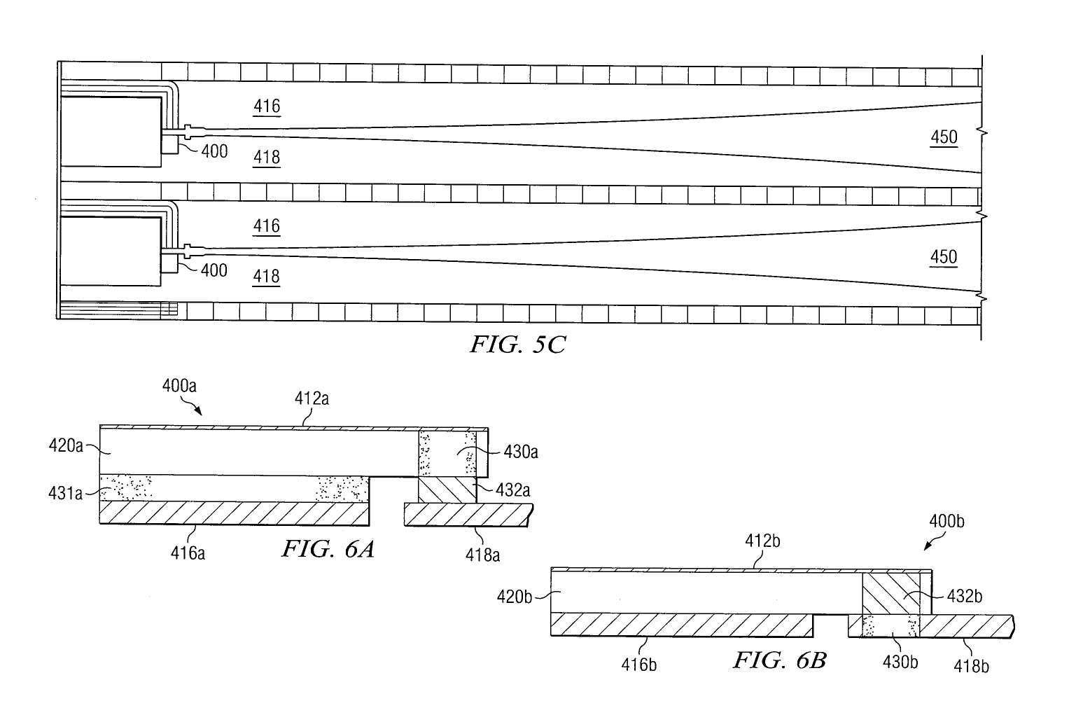

FIGS. 5A, 5B, and 5C provide one illustrative example of a magnetic interconnect device that may be incorporated into an antenna. FIGS. 5A and 5B show an electrical interconnection device 400 according to one embodiment. FIG. 5C shows one embodiment of the electrical interconnection device 400 incorporated into a slotline radiator.

The example embodiment features a first substrate 416, a second substrate 418, and a third substrate 420. In one embodiment, the third substrate 420 may be coupled to an unbalanced line 412 that may be configured as part of a balun for coupling with a balanced slotline radiator 450. In this example, the unbalanced line 412 maybe coupled to a magnet 430. One illustrative example of an unbalanced line 412 may include a t-line connector.

The first and second substrates 416 and 418 may represent one of two radiating elements of the slotline radiator 450. Each of the two substrates 416 and 418 may be made of a ferromagnetic material such that the third substrate 420 makes electrical contact with the second substrate 418 when placed in close proximity. Teachings of certain embodiments recognize that, because the third substrate 420 may extend across the slot between the first and second substrates 416 and 418, a balun may be formed for converting an unbalanced line to a balanced line for transmission or reception of electromagnetic radiation from the slotline radiator 450.

Other example antenna embodiments are recognized. As another non-limiting example, magnetic interconnection devices may be incorporated into an antenna array such as the antenna array of U.S. application entitled “Dual-Polarized Antenna Array”, which is being filed concurrently, for Attorney Docket 004578.1812. Teachings of certain embodiments recognize that the ability to disassemble magnetic interconnects may be especially beneficial in the context of antennas and antenna arrays.

Magnetic coupling may be configured according to any suitable arrangement. For example, in FIG. 5B, the magnet 430 is embedded into the third substrate 420, and the second substrate 418 is made from a ferromagnetic material. FIGS. 6A and 6B show two additional example configurations of magnetic coupling arrangements.

FIG. 6A shows an alternative embodiment of a electrical interconnection device 400a. The example embodiment features a first substrate 416a, a second substrate 418a, and a third substrate 420a. The third substrate 420a may be coupled to a conducting element 412a.

In this example, a magnet 430a may be embedded in the third substrate 420a. In some embodiments, the magnet 430a may be electrically coupled to the conducting element 412a. This example also features a magnet layer 431a, which may coupled to the first substrate 416a and/or the third substrate 420a. In one example, the first substrate 416a is made from a ferromagnetic material, and the magnetic layer 431a is coupled to the third substrate 420a and magnetically coupled to the first substrate 416a. This example also features a magnetic coupler 432a, which may be coupled to the second substrate 418a and/or the third substrate 420a. In one example, the magnetic coupler 432a is coupled to the second substrate 418a and magnetically coupled to the magnet 430a embedded in the third substrate 420a. In some embodiments, the second substrate 418a may also be made of a ferromagnetic material.

FIG. 6B shows an alternative embodiment of a electrical interconnection device 400b. The example embodiment features a first substrate 416b, a second substrate 418b, and a third substrate 420b. The third substrate 420b may be coupled to a conducting element 412b.

In this example, a magnet 430b may be embedded in the second substrate 418b, and a magnetic coupler 432b may be embedded in the third substrate 420b. In some embodiments, the magnetic coupler 432b may be electrically coupled to the conducting element 412b. In some embodiments, the second substrate 418b may also be made of a ferromagnetic material. In some embodiments, the first substrate 416b and the third substrate 420b may also be magnetically coupled.

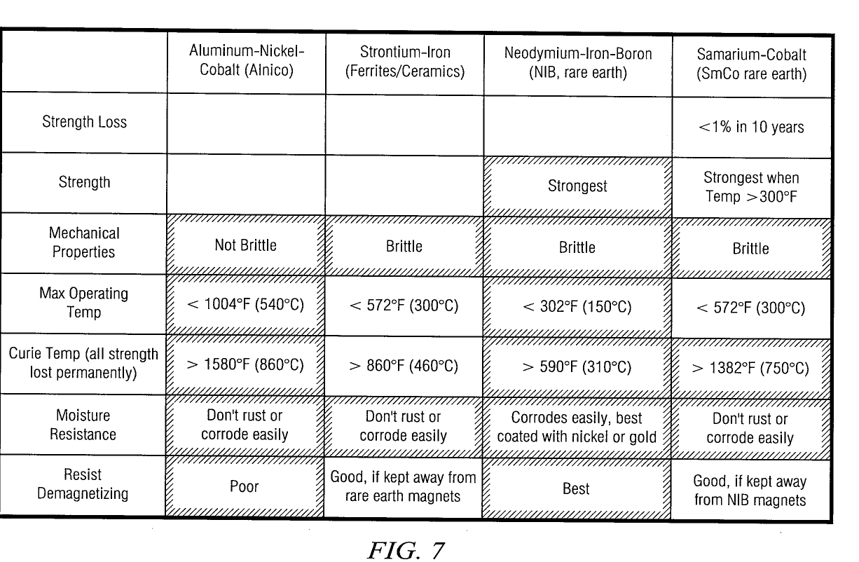

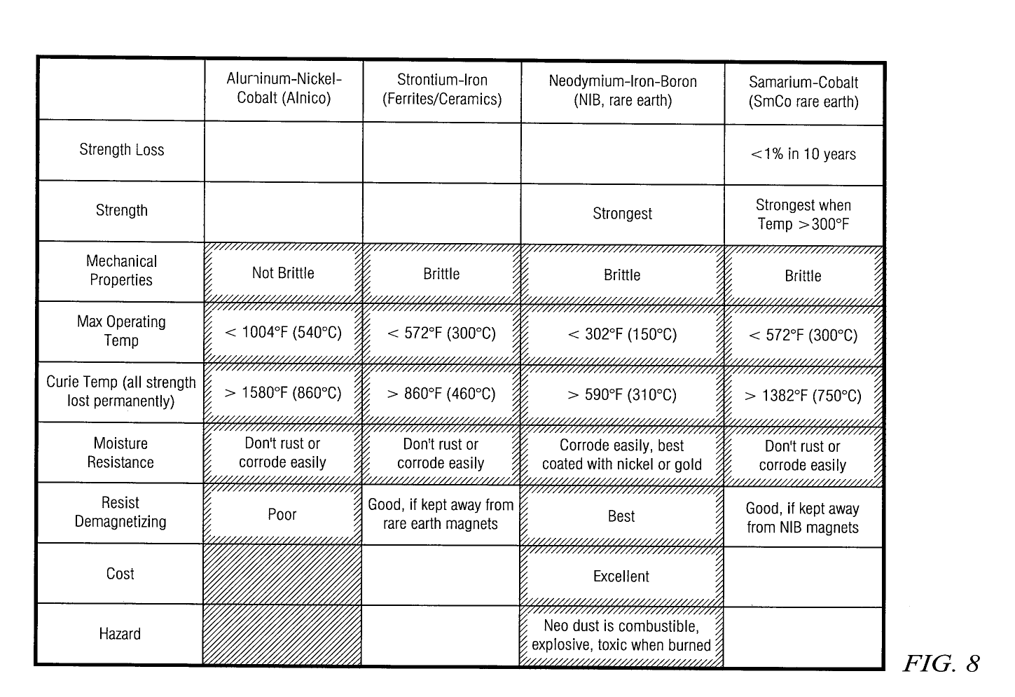

Teachings of certain embodiments recognize the use of magnetic and ferromagnetic material in magnetic interconnection devices. Magnetic and ferromagnetic materials may be any shape and/or size and may include any suitable materials. FIGS. 7 and 8 show non-limiting examples of several magnetic and/or ferromagnetic materials that may be incorporated into an electrical interconnection device. Magnets made of aluminum-nickel-cobalt (alinco), strontium-iron, neodymium-iron-boron (rare Earth), and samarium-cobalt (SmCo) are shown; however, any suitable type of magnet may be implemented with the teachings of the present disclosure. Ferromagnetic materials may include any suitable materials that exhibit an attractive force under the influence of a magnetic field, such as iron or nickel.

Modifications, additions, or omissions may be made to the systems and apparatuses described herein without departing from the scope of the invention. The components of the systems and apparatuses may be integrated or separated. Moreover, the operations-of the systems and apparatuses may be performed by more, fewer, or other components. The methods may include more, fewer, or other steps. Additionally, steps may be performed in any suitable order. As used in this document, “each” refers to each member of a set or each member of a subset of a set.

Although the present invention has been described with several embodiments, a myriad of changes, variations, alterations, transformations, and modifications may be suggested to one skilled in the art, and it is intended that the present invention encompass such changes, variations, alterations, transformation, and modifications as they fall within the scope of the appended claims.

To aid the Patent Office, and any readers of any patent issued on this application in interpreting the claims appended hereto, applicants wish to note that they do not intend any of the appended claims to invoke 6 of 35 U.S.C. §112 as it exists on the date of filing hereof unless the words “means for” or “step for” are explicitly used in the particular claim.

What is claimed is:

1. An apparatus, comprising:
a first magnetic coupling element that is coupled to a first conductive element of an antenna feed circuit; and
a second magnetic coupling element that is coupled to a second conductive element of an antenna radiator circuit, the second magnetic coupling element operable to attract the first magnetic coupling element using a magnetic force such that electrical contact is made between the first conductive element and the second conductive element, wherein:
the first conductive element and the second conductive element are separated by a slot portion, the apparatus further comprising an elongate conductive element, the elongate conductive element extending generally traversely with respect to the slot portion and operable to carry an electrical signal between the antenna feed circuit and the antenna radiator circuit.

2. An apparatus comprising:
a first magnetic coupling element that is coupled to a first conductive element of a first electrical circuit; and
a second magnetic coupling element that is coupled to a second conductive element of a second electrical circuit, the second magnetic coupling element operable to attract the first magnetic coupling element using a magnetic force such that electrical contact is made between the first conductive element and the second conductive element.

3. The apparatus of claim 2, wherein the first magnetic coupling element is formed of a ferromagnetic material.

4. The apparatus of claim 3, wherein the ferromagnetic material is a material that is selected from the group consisting of iron or nickel.

5. The apparatus of claim 2, wherein the second magnetic coupling element is formed of a ferromagnetic material.

6. The apparatus of claim 5, wherein the ferromagnetic material is a material that is selected from the group consisting of iron or nickel.

7. The apparatus of claim 2, wherein the first magnetic coupling element is made of a material that is selected from the group consisting of aluminum-nickel-cobalt, strontium-iron, neodymium-iron-boron, and samarium-cobalt.

8. The apparatus of claim 2, wherein the second magnetic coupling element is made of a material that is selected from the group consisting of aluminum-nickel-cobalt, strontium-iron, neodymium-iron-boron, and samarium-cobalt.

9. The apparatus of claim 2, wherein the first electrical circuit is an antenna feed circuit.

10. The apparatus of claim 2, wherein the second electrical circuit is an antenna radiator circuit.

11. The apparatus of claim 2, wherein:
the first electrical circuit is an unbalanced transmission line, and
the second electrical circuit is a balanced radiator circuit.

12. The apparatus of claim 2, wherein the electrical contact made between the first conductive element and the second conductive element forms an antenna circuit.

13. The apparatus of claim 12, wherein the antenna circuit is selected from the group consisting of striplines, microstrips, coplaner waveguides, digital circuits, and DCs.

14. The apparatus of claim 2, wherein the first conductive element and the second conductive element are separated by a slot portion, the apparatus further comprising an elongate conductive element, the elongate conductive element extending generally traversely with respect to the slot portion and operable to carry an electrical signal between the first electrical circuit and the second electrical circuit.

15. The apparatus of claim 14, wherein the first electrical circuit, the second electrical circuit, and the slot portion forms a slotline radiator.

16. The apparatus of claim 14, wherein the elongate conductive element is coupled to a flexible circuit substrate.

17. The apparatus of claim 14, wherein the elongate conductive element is coupled to a circuit card.

18. The apparatus of claim 14, wherein the elongate conductive element is a microstrip.

19. The apparatus of claim 14, wherein the elongate conductive element is a stripline circuit.

20. The apparatus of claim 14, wherein the slot portion further includes a balun portion.

21. The apparatus of claim 14, wherein:
the first electrical circuit is an unbalanced transmission line, and
the second electrical circuit is a balanced radiator circuit.

22. The apparatus of claim 2, wherein the first conductive element is associated with a first antenna radiator, the second conductive element is associated with a second antenna radiator, and the first and second antenna radiators are arranged such that the first magnetic coupling device faces the second magnetic coupling device.
